(19) United States
(12) Patent Application Publication
(10) Pub. No.: US 2011/0040027 A1
(43) Pub. Date: Feb. 17, 2011

(54) METHODS OF RECYCLING CARPET COMPONENTS AND PRODUCTS FORMED THEREFROM

(76) Inventor: Joseph Z. Keating, Lilburn, GA (US)

Correspondence Address: WITHERS & KEYS, LLC, P. O. BOX 2049, MCDONOUGH, GA, 30253, US

(21) Appl. No.: 12/880,325

(22) Filed: Sep. 13, 2010

Related U.S. Application Data
(63) Continuation-in-part of application No. 12/427,782, filed on Apr. 22, 2009.
Application No. 12/427,782 is a continuation-in-part of application No. 12/789,631, filed on May 28, 2010.

(51) Int. Cl. B02C 7/00; C08L 9/00; C08L 27/00; C08L 67/02; C08L 75/04

(52) U.S. Cl. 524/567; 241/24.28; 524/571; 524/605; 524/589

(57) ABSTRACT

Methods of recycling carpet components are disclosed. Usable compositions containing recycled carpet components, and carpets and carpet components containing recycled carpet components are also disclosed. Other products containing recycled carpet components are further disclosed.

### CROSS-REFERENCE TO RELATED APPLICATIONS

This patent application claims the benefit of priority to and is a continuation-in-part of (i) U.S. patent application Ser. No. 12/427,782 filed on Apr. 22, 2009 and (ii) U.S. patent application Ser. No. 12/789,631 filed on May 28, 2010, the subject matter of both of which is hereby incorporated by reference in its entirety.

### TECHNICAL FIELD

The present invention relates to methods of recycling carpet components, usable compositions containing recycled carpet components, and new carpets, carpet components, and other products containing recycled components.

### BACKGROUND

Efforts continue to further develop ways to effectively and efficiently recycle carpet components.

### SUMMARY

The present invention continues the effort to further develop ways to effectively and efficiently recycle carpet components by the discovery of methods of recycling carpet components previously destined for landfills. The methods of the present invention enable the formation of a free-flowing powder from a tacky first mixture of used carpet components. The resulting free-flowing powder has substantially no tackiness and is suitable for incorporation into new carpet, new carpet components such as a new carpet backing or a new carpet adhesive component, and other new products containing recycled components.

Accordingly, the present invention is directed to methods of recycling carpet components. In one exemplary embodiment, the method of recycling carpet components comprises converting post consumer carpet comprising a latex backing into a free-flowing powder having an average particle size, the free-flowing powder being suitable for incorporation into one or more products as a recycled product component. The step of converting post consumer carpet comprising a latex backing into a free-flowing powder may comprise one or more processing steps as discussed further below.

In one exemplary embodiment, the method of converting post consumer carpet comprising a latex backing into a free-flowing powder comprises shredding the post consumer carpet comprising a latex backing to form a first mixture of carpet components, the first mixture of carpet components comprising carpet fibers, a latex-based carpet backing component, and used filler material (e.g., limestone); and separating at least a portion of the carpet fibers from the first mixture so as to form a second mixture comprising residual carpet fibers, the latex-based carpet backing component, and the used filler material.

As discussed herein, additional processing steps may be utilized to convert post consumer carpet comprising a latex backing into free-flowing powder. Suitable additional processing steps may include, but are not limited to, shearing a carpet pile on the post consumer carpet to remove at least a portion of the carpet fibers prior to the shredding step; heating the second mixture to (i) a first temperature of from about 100° C. to about 250° C. to kill bacteria and truncate any residual fibers, (ii) a second temperature of from about 150° C. to about 400° C. to burn off at least some (or all) volatiles in the second mixture and at least partially decompose the latex-based carpet backing component, or (iii) a third temperature of from about 400° C. to about 600° C. to remove organic material from the second mixture without negatively impacting any used filler material therein; grinding the second mixture alone, wherein the grinding step results in a third mixture comprising the free-flowing powder; blending or co-grinding the second mixture with a solid inorganic particulate material that may be at least partially encapsulated within or coated with a polymeric or resinous material, wherein the blending or co-grinding step results in a third mixture comprising the free-flowing powder; and heating the third mixture to (i) a first temperature of from about 100° C. to about 250° C. to kill bacteria and truncate any residual fibers, (ii) a second temperature of from about 150° C. to about 400° C. to burn off at least some (if not all) volatiles in the third mixture and at least partially decompose the latex-based carpet backing component, or (iii) a third temperature of from about 400° C. to about 600° C. to remove organic material from the third mixture without negatively impacting any filler material therein.

In another exemplary embodiment, the method of converting post consumer carpet comprising a latex backing into a free-flowing powder comprises shredding the post consumer carpet comprising a latex backing to form a first mixture of carpet components comprising carpet fibers, a latex-based carpet backing component, and used filler material; separating at least a portion of (desirably, most of) the carpet fibers from the first mixture of carpet components so as to form a second mixture comprising residual carpet fibers, the latex-based carpet backing component, and the used filler material; and co-grinding the second mixture with a solid inorganic particulate material that may be at least partially encapsulated within and/or coated with a polymeric or resinous material (i.e., may be completely free of organic, polymeric or resinous material or may comprise organic, polymeric and/or resinous material), wherein the co-grinding step results in a third mixture comprising a free-flowing powder having an average particle size. Typically, the free-flowing powder has an average particle size of less than 50 microns (μm), and a particle size range of from about 1.0 μm to about 300 μm. However, as discussed herein, in some embodiments (e.g., free-flowing powder for use in concrete products), the free-flowing powder may have an average particle size of up to or greater than 6000 μm.

The present invention is further directed to the free-flowing powder resulting from the disclosed methods of recycling carpet components. In one exemplary embodiment, the free-flowing powder comprises particles of recycled carpet material, the recycled carpet material comprising residual carpet fibers or carpet fiber portions, a latex-based carpet backing component, and used filler material, wherein the free-flowing powder has an average particle size ranging from about 1.0 to about 10,000 microns (μm).

In another exemplary embodiment, the free-flowing powder comprises (i) particles of recycled carpet material, the recycled carpet material comprising residual carpet fibers or carpet fiber portions, a latex-based carpet backing component, and used filler material; and (ii) solid inorganic particulate material, the solid inorganic particulate material being from a source other than recycled carpet material, wherein the free-flowing powder has an average particle size ranging from about 1.0 to about 10,000 μm.

In yet another exemplary embodiment, the free-flowing powder comprises (i) particles of recycled carpet material, the recycled carpet material comprising residual carpet fibers or carpet fiber portions, a latex-based carpet backing component, and used filler material; (ii) solid inorganic particulate material, the solid inorganic particulate material being from a source other than recycled carpet material; and (iii) a polymeric or resinous material separated from the solid inorganic particulate material or at least partially encapsulating and/or coating the solid inorganic particulate material, wherein the free-flowing powder has a particle size ranging from about 1.0 to about 10,000 μm.

The present invention is even further directed to various products comprising the free-flowing powder resulting from the disclosed methods of recycling carpet components (i.e., post consumer carpet comprising a latex backing). In one exemplary embodiment, the product containing recycled post consumer carpet comprising a latex backing comprises a new carpet component such as a new carpet backing or adhesive suitable for use in a new carpet. In this exemplary embodiment, the new carpet component comprises free-flowing powder, wherein the free-flowing powder comprises (i) particles of recycled carpet material, the recycled carpet material comprising residual carpet fibers or carpet fiber portions, a latex-based carpet backing component, and used filler material; (ii) possibly solid inorganic particulate material, the solid inorganic particulate material being from a source other than recycled carpet material; and possibly (iii) a polymeric or resinous material separated from the solid inorganic particulate material or at least partially encapsulating or coating the solid inorganic particulate material, wherein the free-flowing powder has a particle size ranging from about 1.0 to about 300 microns (μm). The carpet component may further comprise one or more additional components such as a polymeric matrix material. In desired embodiments, the new carpet component comprises at least about 25 wt % and up to about 80 wt % of the free-flowing powder formed from the post consumer carpet, wherein all weight percents are based on a total weight of the new carpet component.

In another exemplary embodiment, the product containing recycled post consumer carpet derived from a latex backing comprises a concrete product. Suitable concrete products include, but are not limited to, dry concrete mix (i.e., concrete sand), stucco, a concrete block, a concrete mixture, a glass fiber reinforced concrete (GFRC), or a pre-cast concrete. In this exemplary embodiment, the new concrete product comprises free-flowing powder, wherein the free-flowing powder comprises (i) particles of recycled carpet material, the recycled carpet material comprising residual carpet fibers or carpet fiber portions, a latex-based carpet backing component, and used filler material; (ii) optional solid inorganic particulate material, the solid inorganic particulate material being from a source other than recycled carpet material; and possibly (iii) a polymeric or resinous material separated from the solid inorganic particulate material or at least partially encapsulating or coating the solid inorganic particulate material, wherein the free-flowing powder has a particle size ranging from about 1.0 to about 10,000 microns (μm). Typically, the free-flowing powder, in this exemplary embodiment, acts as a light-weight reinforcing sand for the concrete product, has an average particle size of less than about 0.25 inches, and comprises residual carpet fibers, the residual carpet fibers providing fiber reinforcement within the concrete product.

The present invention is further directed to other products containing recycled post consumer carpet comprising a latex backing. Other products include, but are not limited to, new carpet, polymeric coating compositions comprising the free-flowing powder formed in the disclosed methods. For example, one exemplary polymeric coating composition comprises a roof coating composition comprising (i) at least one polymeric material and (ii) the free-flowing powder, formed in the disclosed methods, dispersed therein.

These and other features and advantages of the present invention will become apparent after a review of the following detailed description of the disclosed embodiments and the appended claims.

### BRIEF DESCRIPTION OF THE FIGURE

The present invention is further described with reference to the appended figures, wherein:

FIG. 1 depicts a flow diagram of an exemplary method of recycling carpet or carpet components according to the present invention;

FIG. 2 depicts a flow diagram of another exemplary method of recycling carpet or carpet components according to the present invention; and

FIG. 3 depicts a flow diagram of another exemplary method of recycling carpet or carpet components according to the present invention.

### DETAILED DESCRIPTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

The present invention is directed to methods of recycling carpet components, and in particular, methods of recycling post consumer carpet comprising a latex backing such as post consumer broadloom or tile carpet comprising a latex backing. The present invention is further directed to the free-flowing powder resulting from the disclosed methods of recycling carpet components. The present invention is even further directed to new products comprising recycled components such as the free-flowing powder resulting from the disclosed methods of recycling carpet components.

In one exemplary embodiment, the method of recycling carpet components comprises converting post consumer carpet comprising a latex backing (e.g., post consumer broadloom or tile carpet) into a free-flowing powder having an average particle size, the free-flowing powder being suitable for incorporation into one or more products as a recycled product component. In one exemplary embodiment, the method of converting post consumer carpet comprising a latex backing into a free-flowing powder comprises optionally shaving carpet pile from a face of the post consumer carpet comprising a latex backing; shredding the post consumer carpet comprising a latex backing to form a first mixture of carpet components, the first mixture of carpet components comprising carpet fibers, a latex-based carpet backing component, and used filler material; and separating at least a portion of the carpet fibers from the first mixture so as to form a second mixture comprising residual carpet fibers, the latex-based carpet backing component, and the used filler material.

In another exemplary embodiment, the method of recycling carpet components (e.g., post consumer broadloom or tile carpet having a latex backing or components thereof) comprises separating at least a portion of fibers from a first mixture of carpet components comprising carpet fibers, a latex-based carpet backing component, and used filler material so as to form a second mixture comprising residual carpet fibers, the latex-based carpet backing component, and the used filler material; and grinding the second mixture to result in a third mixture comprising a free-flowing powder having an average particle size.

In yet another exemplary embodiment, the method of recycling carpet components (e.g., post consumer broadloom or tile carpet having a latex backing or components thereof) comprises separating at least a portion of fibers from a first mixture of carpet components comprising carpet fibers, a latex-based carpet backing component, and used filler material so as to form a second mixture comprising residual carpet fibers, the latex-based carpet backing component, and the used filler material; and blending or co-grinding the second mixture with a solid inorganic particulate material that (i) may be at least partially encapsulated within or coated with a polymeric or resinous material and (ii) is from a source other than used carpet or used carpet components, wherein the blending or co-grinding step results in a third mixture comprising a free-flowing powder having an average particle size.

An exemplary first mixture of carpet components may be formed from post consumer carpet comprising a latex backing (e.g., formed from post consumer broadloom or tile carpet comprising a latex backing) and may comprise from about 40 to about 60 wt % of the carpet fibers; from about 5.0 to about 20 wt % of the latex-based carpet backing component; and from about 15 to about 40 wt % of the used filler material; wherein all weight percentages are based on a total weight of the first mixture (e.g., the shredded post consumer carpet comprising a latex backing).

Prior to processing, the first mixture (e.g., formed from post consumer broadloom or tile carpet comprising a latex backing) comprises a tacky, conglomerating mixture that alone is incapable of being ground into a free-flowing powder due to (i) the tackiness of the carpet adhesive component (e.g., the latex-based carpet backing component) and (ii) the relatively high level of fibers within the first mixture. The methods of the present invention enable the tacky first mixture to be converted into a free-flowing powder by separating at least a portion of fibers, desirably, a majority of the fibers (e.g., greater than 90 wt % of the fibers, or greater than 95 wt % of the fibers, or greater than 99 wt % of the fibers), from the first mixture to form a second mixture comprising residual carpet fibers, the latex-based carpet backing component, and the used filler material, and further processing the second mixture.

As discussed herein, in some embodiments, the second mixture is ground without other additives to form a free-flowing powder. In other embodiments, the second mixture is blended or co-ground with solid inorganic particulate material. The co-grinding step results in a free-flowing powder, wherein at least a portion of the free-flowing powder comprises particles comprising (i) a portion of the latex-based carpet backing component blended or mixed with at least one of (ii) a portion of the solid inorganic particulate material, and (iii) a polymeric or resinous material that at least partially encapsulated or coated the co-ground solid inorganic particulate material prior to the co-grinding step.

In some embodiments, the second mixture may be heated to a temperature so as to reduce or remove the tackiness of the second mixture. The resulting second mixture may then be ground alone or optionally blended and/or co-ground with solid inorganic particulate material as discussed above and herein.

In the disclosed methods, the separating step may comprise any separation step that removes at least a portion of carpet fibers from the tacky first mixture. Suitable separation steps include, but are not limited to, one or more screening steps, one or more gravity separation steps, one or more air classification steps, or any combination thereof. In some desired embodiments, the separation step comprises processing the first mixture through one or more screening steps utilizing, for example, one or more screens having a screen mesh size ranging from about 10 to about 80 mesh (e.g., a sieve opening size of from about 0.18 to about 2.0 millimeters (mm)). As discussed above, typically, a majority of the carpet fibers are removed during the separating step (or multiple separating steps), Desirably, the resulting second mixture comprises less than about 5.0 wt % fibers (or less than about 1.0 wt % fibers) based on a total weight of the second mixture.

In the co-grinding step, an effective amount of optional solid inorganic particulate material that (i) may be at least partially encapsulated within and/or coated with a polymeric or resinous material and (ii) is typically from a source other than the carpet industry is co-ground with the second mixture in order to form a free-flowing powder. The co-grinding step (or grinding step) may comprise processing the second mixture through one or more grinding mills such as one or more hammer mills, one or more ball mills, one or more roller mills, or any combination thereof.

In some exemplary embodiments, solid inorganic particulate material that may be at least partially encapsulated within and/or coated with a polymeric or resinous material is added to the second mixture so as to form a third mixture, wherein the third mixture comprises from about 10 to about 90 weight percent (wt %) of the second mixture, and from about 90 to about 10 weight percent (wt %) of the solid inorganic particulate material that may be at least partially encapsulated within and/or coated with a polymeric or resinous material. In more desired embodiments, solid inorganic particulate material that may be at least partially encapsulated within and/or coated with a polymeric or resinous material is added to the second mixture so as to form a third mixture, wherein the third mixture comprises from about 20 to about 80 weight percent (wt %) of the second mixture, and from about 80 to about 20 weight percent (wt %) of the solid inorganic particulate material that may be at least partially encapsulated within and/or coated with a polymeric or resinous material.

Suitable solid inorganic particulate material for use in the blending and/or co-grinding step(s) of the present invention includes, but is not limited to, (i) new filler material selected from calcium carbonate, limestone, alumina trihydrate, brucite (i.e., magnesium hydroxide), feldspar, dolomite, silica, clay, granite, barium sulfate, hematite or other iron minerals, any other mineral that can be processed into a powder, or any combination thereof; (ii) post industrial filler material selected from calcium carbonate, limestone, alumina trihydrate, brucite (i.e., magnesium hydroxide), feldspar, dolomite, silica, clay, granite, barium sulfate, hematite or other iron minerals, any other mineral that can be processed into a powder, fly ash, glass (e.g., e-glass), and any combination thereof; (iii) post consumer filler material comprising post consumer glass, recycled paper, calcium carbonate, limestone, feldspar, dolomite, silica, clay, granite, barium sulfate, hematite or other iron minerals, any other mineral that can be processed into a powder, and any combination thereof; or (iv) any combination of any of (i), (ii) and (iii). In some exemplary embodiments, the solid inorganic particulate material comprises calcium carbonate and/or limestone. In some exemplary embodiments, the solid inorganic particulate material comprises post consumer glass (e.g., ground glass) from post consumer glass sources such as beverage containers, vehicle windshields, fluorescent lights, other post consumer glass containers (e.g., jars), or any combination thereof.

In other exemplary embodiments, the solid inorganic particulate material for use in the blending and/or co-grinding step(s) of the present invention comprises solid inorganic particulate material that is at least partially encapsulated within and/or coated with a polymeric or resinous material. As used herein, “at least partially encapsulated within a polymeric or resinous material” describes solid inorganic particulate material, such as any one of the above-described solid inorganic particulate materials or any combination of the above-described solid inorganic particulate materials, partially embedded (i.e., a portion of one or more particles is exposed) or completely embedded (i.e., the particles are not exposed) within a polymeric or resinous material.

Solid inorganic particulate material that is at least partially encapsulated within and/or coated with a polymeric or resinous material includes, but is not limited to, any solid inorganic particulate material or combination of solid inorganic particulate materials, such as any of the above-described solid inorganic particulate materials, in combination with a polymeric or resinous material. Typically, the polymeric or resinous material is in a hardened state (e.g., a solid thermoplastic material, and/or a thermoset material) with little, if any, tackiness (e.g., a PVC tile); however, in some embodiments, the polymeric or resinous material may be a flowable material with or without a degree of tackiness (e.g., asphalt).

Typically, the solid inorganic particulate material that is at least partially encapsulated within and/or coated with a polymeric or resinous material comprises post-consumer material. More typically, the solid inorganic particulate material that is at least partially encapsulated within and/or coated with a polymeric or resinous material comprises post-consumer material that does not originate within the carpet industry. Two examples of particularly useful solid inorganic particulate material that is at least partially encapsulated within and/or coated with a polymeric or resinous material for use in the present invention comprise polyvinyl chloride (PVC) tiles and asphalt based pavement. Recyclable PVC tile typically comprises about 87 wt % limestone and about 13 wt % PVC resin. Recyclable asphalt-based pavement typically comprises a mixture of about 95 wt % mixed solid inorganic particulate materials of limestone, dolomite, silica, and feldspar, and about 5 wt % asphalt tar.

With regard to recyclable PVC tile and similar recyclable materials used as the blended and/or co-ground solid inorganic particulate material, given the relatively small size of the solid inorganic particulate material (e.g., the limestone typically having a particle size of less than 300 μm) embedded within the hardened polymeric resin (e.g., the PVC resin) of the recyclable tile (and similar recyclable materials), free-flowing powder resulting from blended and/or co-grinding of the recyclable PVC tile (or similar recyclable materials) typically comprises particles comprising (i) a portion of the latex-based carpet backing component at least partially surrounded by (ii) a portion of the blended and/or co-ground solid inorganic particulate still embedded within the hardened polymeric resin (e.g., the PVC resin).

With regard to recyclable asphalt and similar recyclable materials, given the relatively large size of the solid inorganic particulate material (e.g., the aggregate may have particle sizes of up to 0.5 inch or greater) embedded within the hardened resin (e.g., the asphalt resin) of the recyclable asphalt, free-flowing powder resulting from blending and/or co-grinding of the recyclable asphalt (or similar recyclable materials) typically comprises particles comprising (i) a portion of the latex-based carpet backing component at least partially surrounded by (ii) a portion of the solid inorganic particulate previously embedded within the hardened resin (e.g., the asphalt resin) with possible additional solid inorganic particulate previously embedded within the hardened resin (e.g., the asphalt resin) dispersed throughout the free-flowing powder.

As discussed above, the solid inorganic particulate materials may be either used alone or mixed in some combination, and may be derived from natural sources, post consumer sources (i.e., recycled solid inorganic particulate material), typically other than the carpet industry (e.g., glass), and/or post consumer sources recycled and comprising a mixture of solid inorganic particulate material with one or more organic compounds/polymers/resins. Typically, the organic content of the solid inorganic particulate material that is at least partially encapsulated within and/or coated with a polymeric or resinous material comprises less than about 20 wt % polymeric or resinous material; however, the organic content of the solid inorganic particulate material that is at least partially encapsulated within and/or coated with a polymeric or resinous material may be much higher (e.g., from about 5 to about 95 wt % solid inorganic particulate material and from about 95 to about 5 wt % polymeric or resinous material).

Polymeric or resinous materials at least partially encapsulating and/or coating the solid inorganic particulate materials may include any post consumer polymeric or resinous material. Exemplary post consumer polymeric or resinous materials include, but are not limited to, PVC resins, asphaltic tars, bitumen, other hydrocarbons, tar, polyolefin resins, thermoplastic polymers and resins, and thermoset polymers and resins.

In some embodiments, an additional process step may be utilized to burn off any of the (desirably, all of the) organic material associated with any of the solid inorganic particulate materials described above. For example, a temperature of from about 400° C. to about 600° C. (desirably, in a reduced oxygen atmosphere) may be utilized to remove organic material from the solid inorganic particulate material as long as the temperature used does not negatively impact the solid inorganic particulate material. The resulting “organic-free” solid inorganic particulate material may be blended or co-ground with the second mixture or utilized alone as a recycled component for the new products of the present invention.

In place of or in addition to the grinding or co-grinding step, any one or combination of the above-mentioned solid inorganic particulate materials (i.e., solid inorganic particulate material alone and/or solid inorganic particulate material that is at least partially encapsulated within and/or coated with a polymeric or resinous material and/or the “organic-free” solid inorganic particulate material) may be added to the second mixture so as to form the third mixture. For example, any one or combination of the above-mentioned solid inorganic particulate materials (i.e., solid inorganic particulate material alone and/or solid inorganic particulate material that is at least partially encapsulated within and/or coated with a polymeric or resinous material and/or the “organic-free” solid inorganic particulate material) may be simply added to and blended with the second mixture (instead of grinding and/or co-grinding) to form the third mixture. In other embodiments, any one or combination of the above-mentioned solid inorganic particulate materials (i.e., solid inorganic particulate materials alone and/or solid inorganic particulate material that is at least partially encapsulated within and/or coated with a polymeric or resinous material and/or the “organic-free” solid inorganic particulate material) may be added to and co-grinded with the second mixture to form the third mixture. In other embodiments, a first portion of any one or combination of the above-mentioned solid inorganic particulate materials (i.e., solid inorganic particulate material alone and/or solid inorganic particulate material that is at least partially encapsulated within and/or coated with a polymeric or resinous material and/or the “organic-free” solid inorganic particulate material) may be added to and co-grinded with the second mixture, and a second portion of any one or combination of the above-mentioned solid inorganic particulate materials (i.e., solid inorganic particulate material alone and/or solid inorganic particulate material that is at least partially encapsulated within and/or coated with a polymeric or resinous material and/or the “organic-free” solid inorganic particulate material) may be added to and blended with the resulting co-ground composition to form the third mixture.

In some exemplary embodiments, the resulting free-flowing powder typically has an average particle size that ranges from about 1.0 to about 50 microns (μm) (or from about 1.0 to about 40 μm, or from about 1.0 to about 30 μm). Further, in some exemplary embodiments, the resulting free-flowing powder typically has a particle size ranging from about 1.0 to about 300 microns (μm) (or from about 1.0 to about 250 μm, or from about 1.0 to about 200 μm, or from about 1.0 to about 150 μm, or from about 1.0 to about 100 μm, or from about 1.0 to about 50 μm).

In other exemplary embodiments, the resulting free-flowing powder typically has an average particle size of up to about 10,000 μm (or from about 4000 to about 7000 μm, or from about 5000 to about 6500 μm). Further, in other exemplary embodiments, the resulting free-flowing powder typically has a particle size ranging from about 1.0 to about 15,000 μm.

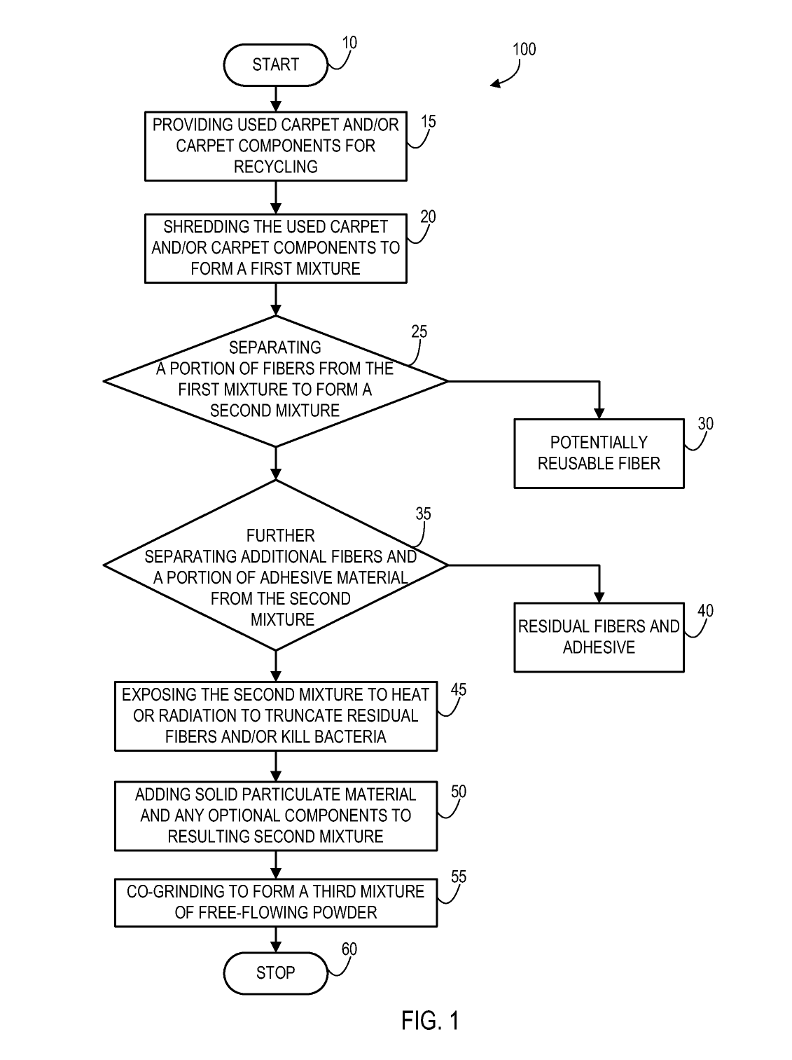

An exemplary method of recycling carpet components according to the present invention is depicted in FIG. 1. As shown in FIG. 1, exemplary method of recycling 100 comprises start 10 followed by step 15, wherein used carpet and/or carpet components (e.g., post consumer broadloom or tile carpet having a latex backing or components thereof) are provided for recycling. From step 15, exemplary method 100 proceeds to step 20, wherein used carpet and/or carpet components are shredded to form a first mixture comprising carpet fibers, a latex-based carpet backing component, and used filler material. From step 20, exemplary method 100 proceeds to first separation step 25, wherein a portion of carpet fibers are separated from and removed from the first mixture to form a second mixture comprising residual carpet fibers, the latex-based carpet backing component, and the used filler material. Desirably, the residual carpet fibers represent less than about 10.0 wt % (or less than about 5.0 wt %, or less than about 3.0 wt %, or less than about 1.0 wt %) of the second mixture following this step.

The removed carpet fibers are shown in box 30 of exemplary method 100. It should be noted that the removed carpet fibers are potentially reusable fibers for carpet applications or other possible uses. Typically, from about 40 to about 60 wt % of the first mixture is recovered as potentially reusable fibers, while about 60 to about 40 wt % of the first mixture remains as the second mixture.

As shown in FIG. 1, from step 20, exemplary method 100 proceeds to second separation step 35, wherein additional residual fibers and a portion of the latex-based carpet backing component is separated from and removed from the second mixture. Desirably, the residual carpet fibers represent less than about 5.0 wt % (or less than about 3.0 wt %, or less than about 1.0 wt %) of the second mixture following this step. The removed additional residual fibers and portion of the latex-based carpet backing component are shown in box 40 of exemplary method 100. Typically, from about 1.0 to about 30 wt % of the second mixture is removed during step 35 in the form of additional residual fibers and a portion of the latex-based carpet backing component, for example, any of the latex-based carpet backing component having a particle size greater than about 4.7 millimeters (mm) (i.e., using a 4 mesh screen). The remaining 99 to 70 wt % of the second mixture proceeds to step 45 of exemplary method 100.

It should be noted that second separation step 35 is not necessary in all embodiments of the present invention. In other words, second separation step 35 is an optional step in some of the methods of the present invention.

In step 45, the second mixture is exposed to heat and/or radiation to truncate the residual fibers and/or kill any bacteria/fungi (collectively referred to as “microorganisms”) present in the second mixture. Typically, when exposed, the second mixture is exposed to a temperature of from about 100 to about 250° C. or UV light (or infrared light) for a time period ranging from about 20 to about 200 seconds.

Optional step 45 also has the added benefit of burning off at least a portion of (and desirably, most of if not all of) the volatile components within the second mixture (e.g., the latex-based carpet backing component). The resulting second mixture is particularly suitable for use as a free-flowing powder in new carpet backings comprising the free-flowing powder and at least one polymer such as polyethylene, polyvinyl chloride (PVC), and other thermoplastic adhesive materials.

It should be noted that exposure step 45 is not necessary in all embodiments of the present invention. In other words, exposure step 45 is an optional step in some of the methods of the present invention.

As shown in FIG. 1, from optional exposure step 45, exemplary method 100 proceeds to step 50, wherein solid particulate material (i.e., solid inorganic particulate material alone and/or solid inorganic particulate material that is at least partially encapsulated within and/or coated with a polymeric or resinous material and/or the “organic-free” solid inorganic particulate material) is added to the second mixture. Any of the above-mentioned solid particulate materials (i.e., solid inorganic particulate material alone and/or solid inorganic particulate material that is at least partially encapsulated within and/or coated with a polymeric or resinous material and/or the “organic-free” solid inorganic particulate material) may be added to the second mixture at this time. It should be noted that other optional components may also be added to the second mixture during this step (or during a subsequent addition step (not shown)). Other optional components that may also be added to the second mixture include, but are not limited to, a biocide, organic flow agents (e.g., propylene or ethylene glycol or triethanolamine), a fire retardant, if not already present (e.g., aluminum trihydrate), or any combination thereof.

From step 45, exemplary method 100 proceeds to step 55, wherein the second mixture, solid particulate material (i.e., solid inorganic particulate material alone and/or solid inorganic particulate material that is at least partially encapsulated within and/or coated with a polymeric or resinous material and/or the “organic-free” solid inorganic particulate material), and any other optional components are co-ground with one another to produce a third mixture comprising a free-flowing powder having a desired particle size. As noted above, typically, in some embodiments, the resulting free-flowing powder has an average particle size of less than 50 μm. In some embodiments, the resulting free-flowing powder has an average particle size ranging from about 15 to about 40 μm. In other embodiments, the resulting free-flowing powder has an average particle size ranging from about 5 to about 30 μm.

In some embodiments, the resulting free-flowing powder contains greater than 10 wt % of post consumer content (e.g., recycled carpet, post consumer glass, recycled paper, recycled polymeric material, etc.) based on a total weight of the resulting free-flowing powder. Desirably, the resulting free-flowing powder contains from about 10 to about 100 wt % (or about 90 wt %) of post consumer content (or any multiple of 5.0 wt % between 10 and 100 wt %) based on a total weight of the resulting free-flowing powder.

It should be understood that steps 50 and 55 may occur substantially simultaneously. In other words, the second mixture, solid particulate material (i.e., solid inorganic particulate material alone and/or solid inorganic particulate material that is at least partially encapsulated within and/or coated with a polymeric or resinous material and/or the “organic-free” solid inorganic particulate material) and any other optional components may be simultaneously added, from one or more sources, directly into a co-grinding apparatus as opposed to mixing/blending prior to advancing to the co-grinding apparatus.

As shown in FIG. 1, from step 55, exemplary method 100 proceeds to stop box 60. Although not shown in FIG. 1, exemplary methods of recycling carpet and/or carpet components, such as exemplary method 100, may further comprise additional process steps as discussed herein. For example, in some embodiments, the above-described exemplary method (i.e., exemplary method of recycling 100) may further comprise a heating step (e.g., instead of optional step 45) after step 35 (i.e., the further fiber separating step). In this optional step, recycled carpet or a recycled carpet component (e.g., recycled carpet backing) is heated to a temperature of between about 400 to about 600° C. in a reduced oxygen atmosphere so as to remove organics from the recycled carpet or a recycled carpet component. The organics may be routed to a downstream combustion chamber. The resultant “organic-free” recycled carpet or a recycled carpet component may be further processed as described in FIG. 1.

In this exemplary optional step, the temperature of the heating chamber is typically closely regulated to prevent decomposition of any filler material (e.g., limestone and/or dolomitic filler) present in the recycled carpet or a recycled carpet component. For example, if limestone or dolomitic filler decomposes into CaO or MgO and CO₂, the resulting filler material is no longer usable as a filler in a subsequent latex or other carpet backing or adhesive. Decomposition of limestone and dolomite occurs between about 500 and 600° C. Consequently, in some embodiments, a heating temperature of from between 400 and 500° C. is desirable for removing organics from the recycled carpet or a recycled carpet component after shredding. If the heating chamber is not oxygen deficient, the organic content in the heating chamber can possibly ignite, raising the temperature in the heating chamber to a point higher than the decomposition temperature of the limestone and/or dolomite.

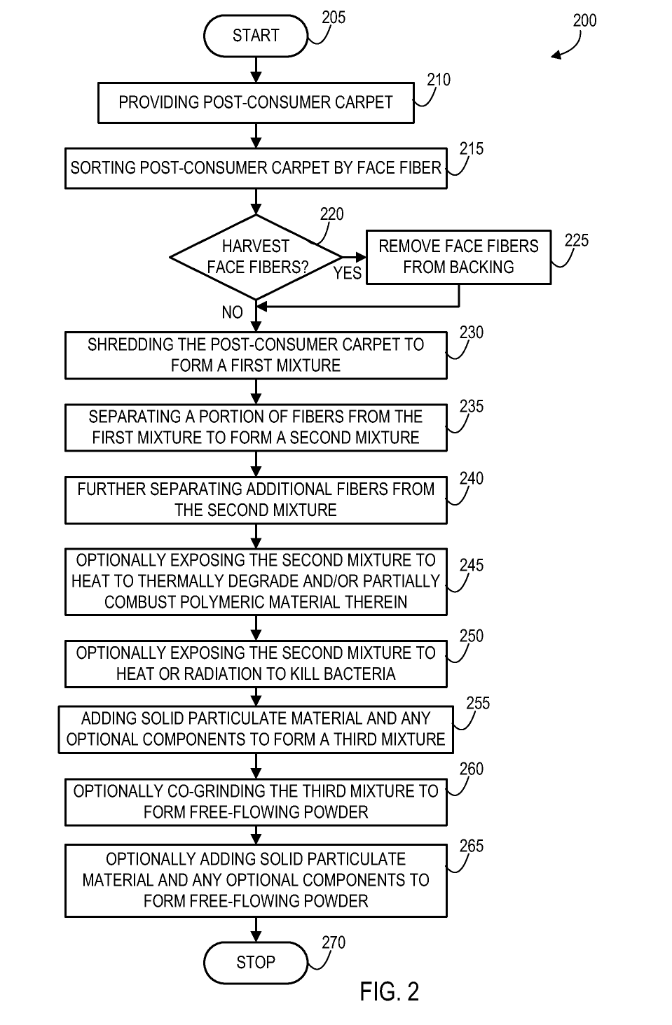

Another exemplary method of recycling carpet components according to the present invention is depicted in FIG. 2. As shown in FIG. 2, exemplary method of recycling 200 comprises start 205 followed by step 210, wherein used, post-consumer carpet is provided for recycling. From step 210, exemplary method 200 proceeds to step 215, wherein the used, post-consumer carpet is sorted by face fiber. For example, in this step, the used, post-consumer carpet may be sorted electronically to identify carpet type. Any conventional method of identifying used, post-consumer carpet may be used including, but not limited to, the use of a face fiber identifying electronic scanner.

From step 215, exemplary method 200 proceeds to decision block 220, where a determination is made whether to harvest face fibers from the used, post-consumer carpet. If a decision is made to harvest face fibers from the used, post-consumer carpet, exemplary method 200 proceeds from decision block 220 to step 225, wherein at least a portion of face fibers are harvested from the used, post-consumer carpet. In this step, as much as about 40 wt % of the used, post-consumer carpet may be collected in the form of harvested face fibers, which may be recycled as used fibers in a variety of application (e.g., in processes to make nylon fibers, and as reinforcements in polymeric or cement compositions such as automotive parts and imitation wood/lumber products).

If a decision is made at decision block 220 not to harvest face fibers from the used, post-consumer carpet, exemplary method 200 proceeds from decision block 220 to step 230, wherein the used, post-consumer carpet is shredded to form a first mixture. Any shredder may be used in this step including, but not limited to, shredders commercially available from, for example, Vecoplan (High Point, N.C.), Granutec (Grand Prairie, Tex.), and SSI (Wilsonville, Oreg.).

From step 230, exemplary method 200 proceeds to first separation step 235, wherein a portion of carpet fibers are separated from and removed from the first mixture to form a second mixture. In this step, the shredded carpet is subjected to any type of equipment that is capable of removing fiber from the shredded carpet. Suitable equipment includes, but is not limited to, step cleaners and other equipment that strips fiber from the backing component. Equipment for performing this step is commercially available from a number of sources including, but not limited to, Southern Megatronics (Covington, Ga.) and Signal Corporation (Kansas City, Mo.).

Carpet fibers removed in step 235 are potentially reusable fibers for carpet applications or other possible uses such as those mentioned above. Typically, as much as from about 40 to about 60 wt % of the first mixture is recovered as potentially reusable fibers, while about 60 to about 40 wt % of the first mixture remains as the second mixture. Typically, the fiber content of the first mixture is reduced from a fiber content level of about 50 wt % to a fiber content level of less than about 5 wt % (or less than about 1.0 wt %) to about 30 wt %.

From step 235, exemplary method 200 proceeds to second separation step 240, wherein additional residual fibers and a portion of the latex-based carpet backing component is separated from and removed from the second mixture. Typically, from about 1.0 to about 30 wt % of the second mixture is removed during step 240 in the form of additional residual fibers and a portion of the latex-based carpet backing component, for example, any of the latex-based carpet backing component having a particle size greater than about 4.7 millimeters (mm) (i.e., using a 4 mesh screen). The remaining 99 to 70 wt % of the second mixture proceeds to step 245 of exemplary method 200.

It should be noted that second separation step 240 is not necessary in all embodiments of the present invention. In other words, second separation step 240 is an optional step in some of the methods of the present invention. When present, second separation step 240 may utilize, for example, one or more screens having a mesh size ranging from about 8 to about 100 mesh with the one or more screens being alone or in series with one another. Further, when present, second separation step 240 removes additional residual fibers so as to obtain a fiber content of less than about 5 wt %, desirably, less than about 1 wt % of fibers in the second mixture.

From step 240, exemplary method 200 proceeds to another optional step, optional step 245, wherein the second mixture is exposed to a relatively high level of heat to thermally degrade and/or partially volatilize polymeric material present in the second mixture. In this step, the second mixture is optionally exposed to heat at a temperature ranging from about 100° C. to about 400° C. The resulting second mixture is particularly suitable for incorporation into new products, wherein process temperatures for producing the new product are in the 150° C. to 250° C. range. For example, the resulting second mixture is particularly suitable for incorporation into new carpet backing products such as polyethylene or PVC-based new carpet backing products.

From step 245, exemplary method 200 proceeds to another optional step, optional step 250, wherein the second mixture is exposed to heat and/or radiation to truncate any residual fibers and/or kill any bacteria/fungi (collectively referred to as “microorganisms”) present in the second mixture. Typically, when exposed, the second mixture is exposed to a temperature of from about 100 to about 250° C. or infrared light for a time period ranging from about 20 to about 200 seconds.

It should be noted that exposure step 250 is not necessary in all embodiments of the present invention. In other words, exposure step 250 is an optional step in some of the methods of the present invention.

As shown in FIG. 2, from optional exposure step 250, exemplary method 200 proceeds to step 255, wherein solid particulate material (i.e., solid inorganic particulate material alone and/or solid inorganic particulate material that is at least partially encapsulated within and/or coated with a polymeric or resinous material and/or the “organic-free” solid inorganic particulate material) is added to the second mixture. Any of the above-mentioned solid particulate materials (i.e., solid inorganic particulate material alone and/or solid inorganic particulate material that is at least partially encapsulated within and/or coated with a polymeric or resinous material and/or the “organic-free” solid inorganic particulate material) may be added to the second mixture at this time. It should be noted that other optional components may also be added to the second mixture during this step (or during a subsequent addition step (i.e., step 265)). Other optional components that may also be added to the second mixture include, but are not limited to, a biocide, organic flow agents (e.g., propylene or ethylene glycol or triethanolamine), a fire retardant, if not already present (e.g., aluminum trihydrate), or any combination thereof.

From step 255, exemplary method 200 proceeds to step 260, wherein the second mixture, solid particulate material (i.e., solid inorganic particulate material alone and/or solid inorganic particulate material that is at least partially encapsulated within and/or coated with a polymeric or resinous material and/or the “organic-free” solid inorganic particulate material), and any other optional components are optionally co-ground with one another to produce a third mixture comprising a free-flowing powder having a desired particle size. As noted above, in some exemplary embodiments, the resulting free-flowing powder has an average particle size of less than 50 μm. In some embodiments, the resulting free-flowing powder has an average particle size ranging from about 15 to about 40 μm. In other embodiments, the resulting free-flowing powder has an average particle size ranging from about 5 to about 30 μm.

In some embodiments, the resulting free-flowing powder contains greater than 10 wt % (or greater than 20 wt %, or greater than 30 wt %, or greater than 40 wt %) of post consumer carpet (e.g., recycled carpet such as post consumer carpet comprising a latex backing), and greater than 20 wt % (or greater than 30 wt %, or greater than 40 wt %, or greater than 50 wt %) of post consumer content (e.g., recycled carpet such as post consumer carpet comprising a latex backing, post consumer glass, recycled paper, recycled asphalt, recycled PVC tile, etc.). Desirably, the resulting free-flowing powder contains from about 30 (or about 40 wt %, or about 50 wt %, or about 60 wt %, or about 70 wt %, or about 80 wt %) to about 100 wt % (or to about 90 wt %) of post consumer carpet (e.g., recycled carpet such as post consumer carpet comprising a latex backing) and, more desirably, from about 40 (or about 50 wt %, or about 60 wt %, or about 70 wt %, or about 80 wt %) to about 100 wt % (or to about 90 wt %) of post consumer carpet (e.g., recycled carpet). Desirably, the resulting free-flowing powder contains from about 30 (or about 40 wt %, or about 50 wt %, or about 60 wt %, or about 70 wt %, or about 80 wt %) to about 100 wt % (or to about 90 wt %) of post consumer content (e.g., recycled carpet, post consumer glass, recycled paper, recycled asphalt, recycled PVC tile, etc.) and, more desirably, from about 40 (or about 50 wt %, or about 60 wt %, or about 70 wt %, or about 80 wt %) to about 100 wt % (or to about 90 wt %) of post consumer content (e.g., recycled carpet, post consumer glass, recycled paper, recycled asphalt, recycled PVC tile, etc.).

It should be understood that steps 255 and 260 may occur substantially simultaneously. In other words, the second mixture, solid particulate material (i.e., solid inorganic particulate material alone and/or solid inorganic particulate material that is at least partially encapsulated within and/or coated with a polymeric or resinous material and/or the “organic-free” solid inorganic particulate material) and any other optional components may be simultaneously added, from one or more sources, directly into a co-grinding apparatus as oppose to mixing/blending prior to advancing to the co-grinding apparatus.

From step 260, exemplary method 200 proceeds to optional step 265, wherein solid particulate material (i.e., solid inorganic particulate material alone and/or solid inorganic particulate material that is at least partially encapsulated within and/or coated with a polymeric or resinous material and/or the “organic-free” solid inorganic particulate material) is added to the third mixture to form the free-flowing powder. Any of the above-mentioned solid particulate materials (i.e., solid inorganic particulate material alone and/or solid inorganic particulate material that is at least partially encapsulated within and/or coated with a polymeric or resinous material and/or the “organic-free” solid inorganic particulate material) may be added to the third mixture at this time. It should be noted that other optional components may also be added to the third mixture during this step. Other optional components that may also be added to the third mixture include, but are not limited to, a biocide, organic flow agents (e.g., propylene or ethylene glycol or triethanolamine), a fire retardant, if not already present (e.g., aluminum trihydrate), or any combination thereof.

As shown in FIG. 2, from step 265, exemplary method 200 proceeds to stop box 270. Although not shown in FIG. 2, exemplary methods of recycling carpet and/or carpet components, such as exemplary method 200, may further comprise additional process steps as discussed herein.

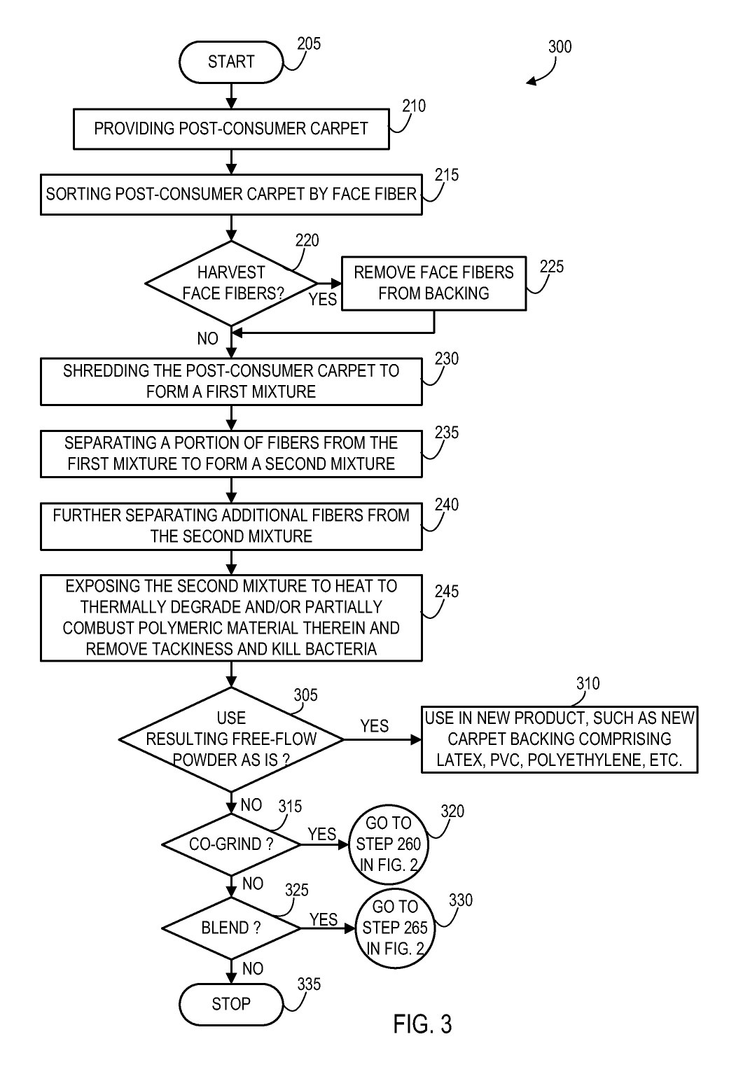

Another exemplary method of recycling carpet or carpet components according to the present invention is depicted in FIG. 3. As shown in FIG. 3, exemplary method of recycling 300 proceeds as discussed above with regard to exemplary method of recycling 200. In step 245, the second mixture is exposed to a relatively high level of heat to thermally degrade and/or partially volatilize polymeric material present in the second mixture, as well as to remove the tackiness and to kill any microorganisms present in the second mixture. In this step, the second mixture is exposed to heat at a temperature ranging from about 100° C. to about 400° C., more typically, from about 150° C. to about 400° C.

From step 245, exemplary method 300 proceeds to decision block 305, wherein a decision is made to use the resulting free-flowing powder as is or proceed with one or more additional processing steps. If a determination is made at decision block 305 to use the resulting free-flowing powder as is, exemplary method 300 proceeds to step 310, wherein the resulting free-flowing powder is incorporated into a new products. As discussed above, the resulting second mixture from this step is particularly suitable for incorporation into new products, wherein process temperatures for producing the new product are in the 150° C. to 250° C. range. For example, the resulting second mixture is particularly suitable for incorporation into new carpet backing products such as latex, polyethylene or PVC-based new carpet backing products, or into new carpet adhesive components.

If a determination is made at decision block 305 not to use the resulting free-flowing powder as is, exemplary method 300 proceeds to decision block 315, wherein a decision is made to co-grind the resulting free-flowing powder from step 305 with solid particulate material as discussed above. If a determination is made at decision block 315 to co-grind the resulting free-flowing powder from step 305 with solid particulate material as discussed above, exemplary method 300 proceeds to step 320, wherein exemplary method 300 proceeds to step 260 as shown in FIG. 2 and proceeds as discussed above.

If a determination is made at decision block 315 not to co-grind the resulting free-flowing powder from step 305 with solid particulate material, exemplary method 300 proceeds to decision block 325, wherein a decision is made to blend the resulting free-flowing powder from step 305 with solid particulate material as discussed above. If a determination is made at decision block 315 to blend the resulting free-flowing powder from step 305 with solid particulate material, exemplary method 300 proceeds to step 330, wherein exemplary method 300 proceeds to step 265 as shown in FIG. 2 and proceeds as discussed above.

If a determination is made at decision block 325 not to blend the resulting free-flowing powder from step 305 with solid particulate material, exemplary method 300 proceeds to stop block 335. Although not shown in FIG. 3, exemplary methods of recycling carpet and/or carpet components, such as exemplary method 300, may further comprise additional process steps as discussed herein.

In any of the above described exemplary methods, carpet fibers separated from the recycled carpet components (e.g., post consumer carpet comprising a latex backing) may be sold as is or used as a fuel substitute in a given process, such as in the disclosed processes.

The methods of recycling carpet components (e.g., post consumer carpet comprising a latex backing) in accordance with the present invention may further comprise incorporating the free-flowing powder into a new product such as a new carpet or a new carpet component. For example, the free-flowing powder may be incorporated into a new carpet backing, a new carpet adhesive component, a polyethylene, an ethylene vinyl acetate (EVA), a EVA/polyethylene, a polyethylene terephthalate (PET), a polyvinyl chloride, a plastisol, a urethane, a SBR (i.e., styrene-butadiene rubber) latex, a vinyl acetate latex, any other material used to form a new carpet backing, or any combination thereof. Further, the methods of recycling carpet components in accordance with the present invention may further comprise one or more additional method steps including, but not limited to, offering for sale the free-flowing powder, and offering for sale a new product comprising the free-flowing powder.

The present invention is further directed to the free-flowing powder resulting from the disclosed methods of recycling carpet components (e.g., post consumer carpet comprising a latex backing). In its simplest form, the free-flowing powder comprises particles of recycled carpet material, the recycled carpet material comprising residual carpet fibers or carpet fiber portions, a latex-based carpet backing component, and used filler material. As discussed above the exemplary method 300, heat-treated free-flowing powder comprising particles of recycled carpet material, the recycled carpet material comprising residual carpet fibers or carpet fiber portions, a latex-based carpet backing component, and used filler material, may be used as filler material in new carpet backings.

In other embodiments, the free-flowing powder comprises (i) particles of recycled carpet material, the recycled carpet material comprising residual carpet fibers or carpet fiber portions, a latex-based carpet backing component, and used filler material; and (ii) solid inorganic particulate material (i.e., solid inorganic particulate material alone and/or solid inorganic particulate material that is at least partially encapsulated within and/or coated with a polymeric or resinous material and/or the “organic-free” solid inorganic particulate material), the solid inorganic particulate material being from a source other than recycled carpet material; wherein the free-flowing powder has an average particle size depending on the end use.

In some embodiments, the free-flowing powder has an average particle size ranging from about 1.0 to about 50 microns (μm) (or from about 1.0 to about 40 μm, or from about 1.0 to about 30 μm), and a particle size ranging from about 1.0 to about 300 microns (μm) (or from about 1.0 to about 250 μm, or from about 1.0 to about 200 μm, or from about 1.0 to about 150 μm, or from about 1.0 to about 100 μm, or from about 1.0 to about 50 μm). As discussed above, typically, at least a portion of the free-flowing powder comprises particles comprising (i) a portion of the latex-based carpet backing component at least partially surrounded by (ii) a portion of the solid inorganic particulate material (i.e., solid inorganic particulate material alone and/or solid inorganic particulate material that is at least partially encapsulated within and/or coated with a polymeric or resinous material and/or polymeric or resinous material separated from but previously encapsulating and/or coating the solid inorganic particulate material and/or the “organic-free” solid inorganic particulate material).

Further, as discussed above, the free-flowing powder resulting from the disclosed methods of recycling carpet components may comprise from about 30 to 100 weight percent (wt %) of the second mixture (i.e., recycled carpet components formed from post consumer carpet comprising a latex backing), and from about 70 to 0 weight percent (wt %) of the solid inorganic particulate material (i.e., (1) solid inorganic particulate material alone and/or (2) solid inorganic particulate material that is at least partially encapsulated within and/or coated with a polymeric or resinous material and/or (3) polymeric or resinous material separated from but previously encapsulating and/or coating the solid inorganic particulate material and/or (4) the “organic-free” solid inorganic particulate material) (e.g., post consumer filler material). In more desired embodiments, the free-flowing powder resulting from the disclosed methods of recycling carpet components comprises from about 30 (or from about 35 wt %, or from about 40 wt %, or from about 45 wt %, or from about 50 wt %) to about 80 wt % of the second mixture (i.e., recycled carpet components), and from about 70 (or from about 65 wt %, or from about 60 wt %, or from about 55 wt %, or from about 50 wt %) to about 20 wt % of the solid inorganic particulate material (i.e., (1) solid inorganic particulate material alone and/or (2) solid inorganic particulate material that is at least partially encapsulated within and/or coated with a polymeric or resinous material and/or (3) polymeric or resinous material separated from but previously encapsulating and/or coating the solid inorganic particulate material and/or (4) the “organic-free” solid inorganic particulate material) (e.g., new filler material, post industrial filler material, post consumer filler material, “organic-free” solid inorganic particulate material, or any combination thereof).

The free-flowing powder resulting from the disclosed methods of recycling carpet components is compatible with any of the above-mentioned materials used to form carpet backing material. Further, in some embodiments, the free-flowing powder resulting from the disclosed methods of recycling carpet components is sized so as to a suitable replacement or substitute for limestone and other conventional filler materials used in carpet backings. For example, the free-flowing powder resulting from the disclosed methods of recycling carpet components may have a particle size and particle size distribution such that about 40% to about 90% of the free-flowing powder passes through a 325 mesh screen, and a maximum amount of about 5% is larger than 60 mesh.

The present invention is even further directed to new products comprising recycled components such as the free-flowing powder resulting from the disclosed methods of recycling carpet components (e.g., post consumer carpet comprising a latex backing). In one exemplary embodiment, the new product comprises a new carpet or new carpet backing comprises free-flowing powder, wherein the free-flowing powder comprises (i) particles of recycled carpet material, the recycled carpet material comprising residual carpet fibers or carpet fiber portions, a latex-based carpet backing component, and used filler material, wherein the particles of recycled carpet material are utilized alone or in combination with (ii) solid inorganic particulate material (i.e., (1) solid inorganic particulate material alone and/or (2) solid inorganic particulate material that is at least partially encapsulated within and/or coated with a polymeric or resinous material and/or (3) polymeric or resinous material separated from but previously encapsulating and/or coating the solid inorganic particulate material and/or (4) the “organic-free” solid inorganic particulate material), the solid inorganic particulate material being from a source other than recycled carpet material. As discussed above, the free-flowing powder for use within the new carpet or new carpet backing has an average particle size ranging from about 1.0 to about 50 microns (μm) (or from about 1.0 to about 40 μm, or from about 1.0 to about 30 μm), and a particle size ranging from about 1.0 to about 300 microns (μm) (or from about 1.0 to about 250 μm, or from about 1.0 to about 200 μm, or from about 1.0 to about 150 μm, or from about 1.0 to about 100 μm, or from about 1.0 to about 50 μm).

In some exemplary embodiments, the new carpet backing desirably comprises at least about 20 wt % of recycled carpet material (e.g., post consumer carpet comprising a latex backing), such as the exemplary second mixture of carpet components described above, based on a total weight of the new carpet or new carpet backing. In some embodiments, the new carpet backing comprises at least about 25 wt % (or at least about 30 wt %, or at least about 35 wt %, or at least about 40 wt %, or at least about 45 wt %%, or at least about 50 wt %%, or at least about 55 wt %, or at least about 60 wt %, or greater than about 60 wt %) of recycled carpet material (e.g., post consumer carpet comprising a latex backing), such as the exemplary second mixture of carpet components described above, based on a total weight of the new carpet backing.

In some exemplary embodiments, the new carpet desirably comprises at least about 10 wt % of recycled carpet material (e.g., post consumer carpet comprising a latex backing), such as the exemplary second mixture of carpet components described above, based on a total weight of the new carpet. In some embodiments, the new carpet comprises at least about 20 wt % (or at least about 25 wt %, or at least about 30 wt %, or at least about 35 wt %, or at least about 40 wt %, or at least about 45 wt %, or at least about 50 wt %, or at least about 55 wt %, or at least about 60 wt %, or greater than about 60 wt %) of recycled carpet material, based on a total weight of the new carpet.

New carpet is typically made from a combination of fibers such as nylons, polypropylenes and polyesters. The fibers of the new carpet typically comprise from about 40 to about 60 wt % of the new carpet, while the backing material comprises the weight balance of the new carpet. As discussed above, the new backing may comprise any of the above-described free-flowing powders of the present invention in combination with and dispersed throughout one or more polymers (e.g., latex, PVC, EVA/polyethylene, PET, urethanes, and others discussed above).

The new carpet of the present invention comprise the above-mentioned carpet fibers and carpet backing, wherein the carpet backing is loaded with free-flowing powder of the present invention so as to desirably result in a new carpet comprising at least 10 wt % of recycled carpet (i.e., the second mixture described above). The new carpet of the present invention may comprise any amount of recycled carpet (i.e., the second mixture described above), but desirably comprises at least about 10 wt % (or at least about 12 wt %, or at least about 14 wt %, or at least about 16 wt %, or at least about 18 wt %, or at least about 20 wt %, or at least about 25 wt %, or greater than about 25 wt %) of recycled carpet (i.e., the second mixture described above) typically up to about 60 wt % or greater of recycled carpet (i.e., the second mixture described above).

For example, if the carpet backing content of a new carpet is 50 wt % of the total weight of the new carpet, the portion of post consumer recycled carpet (i.e., the second mixture described above) is desirably at least 20 wt % of the carpet backing so as to achieve a 10 wt % overall percent of recycled carpet in the new carpet. Continuing with this example, if the carpet backing consists of 80 wt % filler and 20 wt % latex, then at least about 25 wt % of the filler content is desirably post consumer recycled carpet (i.e., the second mixture described above) so as to achieve a 10 wt % overall percent of recycled carpet in the new carpet. In carpet backing applications where the filler loadings are lower, for example, 60 wt % of the carpet backing weight, then the recycled carpet portion of the filler is desirably 33 wt % of the filler weight so as to achieve a 10 wt % overall percent of recycled carpet in the new carpet.

Other new products of the present invention include concrete-like products containing recycled post consumer carpet comprising a latex backing. Suitable concrete type products include, but are not limited to, dry concrete mix (i.e., concrete sand), stucco, a concrete block, a concrete mixture, a glass fiber reinforced concrete (GFRC), or a pre-cast concrete. The new concrete products comprise free-flowing powder, wherein the free-flowing powder comprises (i) particles of recycled carpet material, the recycled carpet material comprising residual carpet fibers or carpet fiber portions, a latex-based carpet backing component, and used filler material, wherein the particles of recycled carpet material are utilized alone or in combination with (ii) solid inorganic particulate material, the solid inorganic particulate material being from a source other than recycled carpet material; and possibly (iii) a polymeric or resinous material separated from the solid inorganic particulate material or at least partially encapsulating or coating the solid inorganic particulate material.

When used as a filler/reinforcing material for concrete products, the free-flowing powder may have a particle size ranging from about 1.0 to about 10,000 microns (μm). Typically, the free-flowing powder used in these products acts as a lightweight reinforcing sand for the concrete product, has an average particle size of up to or less than about 0.25 inches, and comprises residual carpet fibers, the residual carpet fibers providing fiber reinforcement within the concrete product.

Other products of the present invention containing recycled post consumer carpet comprising a latex backing include, but are not limited to, polymeric coating compositions comprising the free-flowing powder formed in the disclosed methods. For example, one exemplary polymeric coating composition comprises a roof coating composition comprising (i) at least one polymeric material and (ii) the free-flowing powder, formed in the disclosed methods, dispersed therein.

In addition, new products of the present invention comprise any of the above-mentioned products wherein the above-described “organic-free” solid inorganic particulate material is incorporated into the new product alone or in combination with the free-flowing powder formed in the disclosed methods. New products that may comprise the above-described “organic-free” solid inorganic particulate material alone or in combination with the free-flowing powder include, but are not limited to, a new carpet, a new carpet component such as a latex backing or an adhesive component, any of the above-mentioned concrete products, and polymeric coating compositions such as a roof coating.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A method of recycling carpet components, said method comprising:
converting post consumer carpet comprising a latex backing into a free-flowing powder having an average particle size, the free-flowing powder being suitable for incorporation into one or more products as a recycled product component.

2. The method of claim 1, wherein said converting step comprises:
shredding the post consumer carpet comprising a latex backing to form a first mixture of carpet components, the first mixture of carpet components comprising carpet fibers, a latex-based carpet backing component, and used filler material; and
separating at least a portion of the carpet fibers from the first mixture so as to form a second mixture comprising residual carpet fibers, the latex-based carpet backing component, and the used filler material.

3. The method of claim 2, wherein said converting step further comprises:
heating the second mixture to (i) a first temperature of from about 100° C. to about 250° C. to kill bacteria and truncate any residual fibers, (ii) a second temperature of from about 150° C. to about 400° C. to burn off at least some volatiles in the second mixture and at least partially decompose the latex-based carpet backing component, or (iii) a third temperature of from about 400° C. to about 600° C. to remove organic material from the second mixture without negatively impacting any used filler material therein.

4. The method of claim 2, wherein said converting step further comprises:
blending or co-grinding the second mixture with a solid inorganic particulate material, wherein said blending or co-grinding step results in a third mixture comprising the free-flowing powder.

5. The method of claim 3, wherein said converting step further comprises:
grinding the second mixture, wherein said grinding step results in a third mixture comprising the free-flowing powder.

6. The method of claim 4, wherein said converting step further comprises:
co-grinding the second mixture with the solid inorganic particulate material.

7. The method of claim 6, wherein the solid inorganic particulate material is at least partially encapsulated within or coated with a polymeric or resinous material.

8. The method of claim 4, wherein said converting step further comprises:
heating the second or third mixture to (i) a first temperature of from about 100° C. to about 250° C. to kill bacteria and truncate any residual fibers, (ii) a second temperature of from about 150° C. to about 400° C. to burn off at least some volatiles in the second or third mixture and at least partially decompose the latex-based carpet backing component, or (iii) a third temperature of from about 400° C. to about 600° C. to remove organic material from the second or third mixture without negatively impacting any filler material therein.

9. The method of claim 6, wherein said converting step further comprises:
heating the second or third mixture to (i) a first temperature to kill bacteria and truncate any residual fibers, (ii) a second temperature to burn off at least some volatiles in the second or third mixture and at least partially decompose the latex-based carpet backing component, or (iii) a third temperature to remove organic material from the second or third mixture without negatively impacting any filler material therein.

10. The method of claim 1, wherein the post consumer carpet comprises post consumer broadloom or tile carpet comprising a latex backing.

11. The method of claim 10, further comprising:
incorporating the free-flowing powder into one or more products as a recycled product component.

12. The method of claim 11, wherein the one or more products comprise a carpet backing for a new carpet comprising recycled product component.

13. The method of claim 12, wherein the new carpet comprises at least 10 wt % of the free-flowing powder formed from the post consumer carpet, wherein all weight percents are based on a total weight of the new carpet.

14. The method of claim 11, wherein the one or more products comprise a concrete product.

15. The method of claim 14, wherein the concrete product comprises stucco, a concrete block, a concrete mixture, a glass fiber reinforced concrete (GFRC), or a pre-cast concrete.

16. The method of claim 15, wherein the free-flowing powder has an average particle size of less than about 0.25 inches and comprises residual carpet, the residual carpet fibers providing fiber reinforcement within the concrete product.

17. The method of claim 4, wherein the third mixture comprises from about 30 to 90 weight percent (wt %) of the second mixture, and from about 70 to 10 weight percent (wt %) of the solid inorganic particulate material.

18. The method of claim 10, wherein the post consumer broadloom or tile carpet comprising a latex backing comprises:
from about 40 to about 60 wt % of carpet fibers;
from about 5 to about 20 wt % of a latex-based carpet backing component; and
from about 15 to about 40 wt % of and used filler material;
wherein all weight percentages are based on a total weight of the post consumer broadloom or tile carpet comprising a latex backing.

19. A new carpet backing component comprising the free-flowing powder of claim 18.

20. A new concrete product comprising the free-flowing powder of claim 18.
